(19) United States
(12) Patent Application Publication
(10) Pub. No.: US 2025/0391147 A1
(43) Pub. Date: Dec. 25, 2025

(54) MULTIMODAL LARGE LANGUAGE MODEL AGENT WITH INTERACTIVE IMAGE UNDERSTANDING

(71) Applicant: Dell Products L.P., Round Rock, TX (US)

(72) Inventors: Tianlu Fei, Shanghai (CN); Zijia Wang, London (GB); Sanping Li, Beijing (CN); Zhen Jia, Shanghai (CN)

(21) Appl. No.: 18/747,541

(22) Filed: Jun. 19, 2024

(51) Int. Cl. G06V 10/26; G06F 40/40; G06V 10/40

(52) U.S. Cl. CPC G06V 10/26; G06F 40/40; G06V 10/40

(57) ABSTRACT

An apparatus in an illustrative embodiment comprises at least one processing device that includes at least a processor and a memory coupled to the processor. The at least one processing device is configured to implement an artificial intelligence system comprising at least one large language model (LLM) agent, to perform in the LLM agent interactive image segmentation of at least one input image through interaction of the LLM agent with one or more users, to generate in the LLM agent an interactive image understanding comprising attention values computed by multiple distinct attention mechanisms based on one or more results of the interactive image segmentation, and to carry out additional user interactions via the LLM agent utilizing the interactive image understanding comprising the attention values computed by the multiple distinct attention mechanisms. In some embodiments, the LLM agent is illustratively utilized to provide at least a portion of an AI chatbot.

### FIELD

The field relates generally to information processing, and more particularly relates to artificial intelligence.

### BACKGROUND

Artificial intelligence (AI) systems increasingly implement large language models (LLMs), typically based on generative transformer architectures. In some cases, the LLMs more particularly comprise multimodal LLMs, which can integrate multiple content modalities, such as text, images and audio, into a single framework. Multimodal LLMs are characterized by their ability to process and understand multiple data formats, allowing for a more comprehensive understanding of complex datasets. Unfortunately, significant deficiencies exist in conventional multimodal LLMs.

### SUMMARY

Illustrative embodiments of the present disclosure provide multimodal LLM agents with interactive image understanding based on image segmentation.

In one embodiment, an apparatus comprises at least one processing device, with the at least one processing device comprising a processor and a memory coupled to the processor. The at least one processing device is configured to implement an artificial intelligence system comprising at least one LLM agent, to perform in the LLM agent interactive image segmentation of at least one input image through interaction of the LLM agent with one or more users, to generate in the LLM agent an interactive image understanding comprising attention values computed by multiple distinct attention mechanisms based on one or more results of the interactive image segmentation, and to carry out additional user interactions via the LLM agent utilizing the interactive image understanding comprising the attention values computed by the multiple distinct attention mechanisms.

The AI system in some embodiments is implemented at least in part on a processing platform that is configured to communicate with one or more user devices over at least one network.

Additionally or alternatively, the AI system in some embodiments is implemented at least in part on at least one user device.

The LLM agent illustratively comprises a multimodal LLM agent that implements at least one multimodal LLM. Other embodiments can be implemented using other types of LLMs that are not necessarily multimodal.

In some embodiments, performing interactive image segmentation illustratively comprises extracting features from the at least one input image in an image encoder, and applying the extracted features to a semantic concept integration decoder to generate at least one embedding.

Additionally or alternatively, performing interactive image segmentation in some embodiments comprises determining at least a subset of text prompts, visual prompts and memory prompts associated with the at least one input image, and generating at least one embedding comprising at least one of one or more mask embeddings and one or more class embeddings based on the at least a subset of the text prompts, visual prompts and memory prompts and features extracted from the at least one input image.

In some embodiments, generating an interactive image understanding comprises receiving at least one embedding as the one or more results of the interactive image segmentation, and applying the at least one embedding to a transformer architecture comprising the multiple distinct attention mechanisms to generate respective ones of the attention values.

The transformer architecture in some embodiments is configured to treat spatial information and text information as respective separate spatial and text modalities, with at least a portion of the attention values illustratively reflecting interdependencies between the spatial and text modalities.

The multiple distinct attention mechanisms in some embodiments comprise at least a subset of text-to-text attention, text-to-spatial attention, spatial-to-text attention, and spatial-to-spatial attention.

In some embodiments, the LLM agent is illustratively utilized to provide at least a portion of an AI chatbot. The LLM agent can support numerous other use cases in a wide variety of different applications.

Other illustrative embodiments include, by way of example and without limitation, methods and computer program products comprising non-transitory processor-readable storage media.

The foregoing arrangements are presented by way of illustrative example only, and should not be construed as limiting the scope of the present disclosure in any way.

### BRIEF DESCRIPTION OF THE DRAWINGS

FIG. 1 is a block diagram of an information processing system comprising an AI platform that includes multimodal LLM agents with interactive image understanding in an illustrative embodiment.

FIG. 2 is a flow diagram of an example process for interactive image understanding implemented by a multimodal LLM agent in an illustrative embodiment.

FIG. 3 is a block diagram of a multimodal LLM agent with interactive image understanding in an illustrative embodiment.

FIG. 4 is a schematic diagram showing an example of the operation of a multimodal LLM agent with interactive image understanding in an illustrative embodiment.

FIGS. 5 and 6 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that these and other embodiments are not restricted to the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, a wide variety of different arrangements of core-edge architectures comprising different types of core and edge infrastructure components. Numerous different types of enterprise and/or cloud computing and storage systems, as well as other systems and devices, are also encompassed by the term “information processing system” as that term is broadly used herein. A given information processing system may therefore comprise one or more processing devices, each comprising processor and memory components.

As indicated above, multimodal LLMs can integrate multiple content modalities, such as text, images and audio, into a single framework. Multimodal LLMs are characterized by their ability to process and understand multiple data formats, allowing for a more comprehensive understanding of complex datasets. Unfortunately, significant deficiencies exist in conventional multimodal LLMs.

For example, conventional multimodal LLMs are typically limited to simple subject recognition, classification and text description of the content of the input image. However, in many real-world scenarios, users do not focus entirely on the content of the image as a whole, but rather on particular details in the image. Conventional multimodal LLMs are unable to support more sophisticated image processing, and therefore fail to provide optimal results to users based on image content. Moreover, conventional multimodal LLMs face numerous additional challenges, such as data alignment across modalities, managing large-scale datasets, and ensuring model robustness. In some implementations, conventional multimodal LLMs require complex vision encoders and extensive fine-tuning on specific datasets, limiting their adaptability and efficiency. Other challenges in visually-rich document understanding include accurately interpreting spatial layouts, integrating diverse content types, and generalizing across various document formats.

Illustrative embodiments disclosed herein address and overcome these and other drawbacks of conventional approaches. For example, some embodiments provide a multimodal LLM agent with interactive image understanding based on image segmentation. The interactive image understanding in some embodiments allows a user to identify the content that he or she is most concerned about in a user-friendly manner, in a more flexible and interactive form, to be conveyed to the corresponding LLM, thereby fully utilizing the comprehension capability of the LLM to better serve the user.

Additionally or alternatively, a multimodal LLM agent with interactive image understanding based on image segmentation as disclosed in illustrative embodiments herein can perform functionality such as, for example, pre-segmenting images, recognizing and classifying the segmented content, and improving the accuracy of the LLM's understanding of the image content.

Some embodiments disclosed herein implement image segmentation and classification to provide a focus for the image understanding of the LLM agent, and to improve the quality of the image understanding.

For example, by allowing the user to focus on selecting what he or she cares about in an interactive way, illustrative embodiments allow an LLM agent to use the information in the image in a manner that is more accurately based on actual user needs.

As another example, by combining image segmentation with document understanding, an LLM agent in some embodiments is configured to integrate multimodal information from images as well as documents such as tables and contracts. This illustrative approach allows for more accurate comprehension of user needs in numerous professional and other contexts, reducing the occurrence of misunderstandings and enhancing the quality of the LLM agent responses in multiple dimensions.

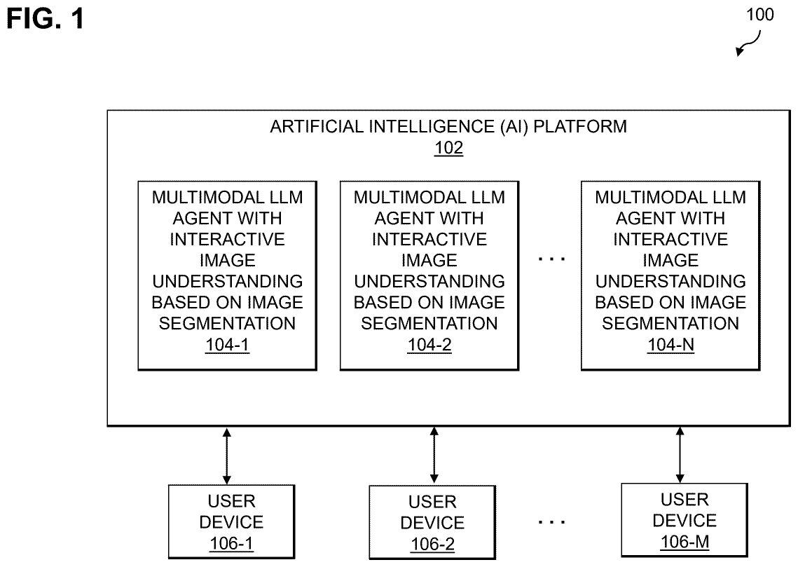

FIG. 1 shows an information processing system 100 configured with functionality for interactive image understanding in a multimodal LLM agent in an illustrative embodiment. The information processing system 100 comprises an artificial intelligence (AI) platform 102 that implements a plurality of multimodal LLM agents 104-1, 104-2, . . . 104-N, collectively referred to herein as LLM agents 104, where N is assumed to be an integer value greater than or equal to one, such that some embodiments may include only a single LLM agent. Each of the LLM agents 104 is configured with interactive image understanding based on image segmentation as disclosed herein. It is to be appreciated that the term “based on” as used in this and other contexts herein is intended to be broadly construed as “based at least in part on.” The AI platform 102 is an example of what is more generally referred to herein as an “AI system.” An AI system as that term is broadly used herein comprises at least a portion of at least one LLM agent, and may also include one or more LLMs. An AI system in some embodiments can be implemented on a single processing device or on a set of multiple processing devices.

The system 100 further comprises a plurality of user devices 106-1, 106-2, . . . 106-M, collectively referred to herein as user devices 106, where M is assumed to be an integer value greater than or equal to one, such that some embodiments may include only a single user device. The user devices 106 are illustratively implemented as respective computers or other types and arrangements of processing devices. Such processing devices can include, for example, desktop computers, laptop computers, tablet computers, mobile telephones, Internet of Things (IoT) devices, or other types of processing devices, as well as combinations of multiple such devices. One or more of the user devices 106 can additionally or alternatively comprise virtualized computing resources, such as virtual machines (VMs), containers, etc. Although the user devices 106 are shown in the figure as being separate from the LLM agents 104, this is by way of illustrative example only, and in other embodiments one or more of the LLM agents 104 may be implemented at least in part within one or more of the user devices 106.

Accordingly, in some embodiments, at least portions of the AI platform 102 may be implemented internally to one or more of the user devices 106. For example, each of the user devices 106 may incorporate one or more of the LLM agents 104. Numerous other operating scenarios involving a wide variety of different types and arrangements of processing devices are possible, as will be appreciated by those skilled in the art. For example, an “AI system” as the term is broadly used herein in some embodiments comprises an AI system implemented on a single user device, rather than on a separate platform such as AI platform 102.

The AI platform 102 of the system 100 in some embodiments may comprise at least a portion of one or more data centers. For example, the AI platform 102 may comprise, for example, at least one data center implemented at least in part utilizing cloud infrastructure. As other examples, the AI platform 102 in some embodiments may be implemented as or within a software-defined data center (SDDC), a virtual data center (VDC), or other similar dynamically-configurable arrangement. It is to be appreciated, however, that illustrative embodiments disclosed herein do not require the use of cloud infrastructure.

Additionally or alternatively, the AI platform 102 may comprise at least portions of one or more core nodes in a core-edge architecture that includes one or more core computing sites and one or more edge computing sites. The core computing sites may each comprise a plurality of servers or other types and arrangements of one or more core nodes. The edge computing sites may each comprise one or more edge stations or other types and arrangements of edge nodes. Each such node or other computing site comprises at least one processing device that includes a processor coupled to a memory.

The LLM agents 104 are illustratively implemented as software-based agents running on the AI platform 102. Each of the LLM agents 104 incorporates or otherwise has access to at least one LLM. In some embodiments, each of the LLM agents 104 has its own LLM. Again, a given such LLM may but need not be implemented internally to its corresponding LLM agent. Alternatively, multiple ones of the LLM agents 104 may each share the same LLM. For example, the LLM may be viewed as a core controller or other core computation engine for each of the multiple LLM agents. In some embodiments, the LLM is implemented on one or more external servers or other external processing platform that is separate from the LLM agents. Alternatively, the LLM in some embodiments is at least partially implemented within one or more of the LLM agents.

By way of example, in some embodiments, at least one LLM may illustratively comprise a generative pre-trained transformer (GPT) model, such as ChatGPT, GPT-4, LaMDA, LLAMA, MT-NLG and Claude, although a wide variety of other LLMs can be used.

The LLM agents 104 are illustratively configured to interact with one or more LLMs, which in some embodiments may be part of at least one of the LLM agents 104. For example, a given LLM agent as that term is broadly used herein can incorporate at least a portion of an LLM as a core controller or other core computation engine of the LLM agent. In some embodiments, the LLM agents 104 are configured to interact with the same LLM. For example, the LLM may be viewed as a core controller or other core computation engine for each of the multiple LLM agents.

Additionally or alternatively, in some embodiments, the LLM is implemented at least in part on one or more external servers or other external processing platform that is separate from the LLM agents 104. For example, the LLM agents 104 can be configured to access one or more external LLMs, such as one or more LLMs accessible on other processing platforms over one or more networks.

The one or more LLMs associated with the LLM agents 104 are therefore not explicitly shown in the figure, as such LLMs may be part of the LLM agents 104 and/or external to the AI platform 102.

As indicated previously, in some embodiments, the LLM agents 104 share a common LLM, but numerous other arrangements are possible. For example, different fine-tuned instances of a given LLM may be associated with respective different ones of the LLM agents 104. Again, such components can be internal to an LLM agent or external to the LLM agent, and the term “LLM agent” as used herein is therefore intended to be broadly construed. In some embodiments, a given LLM agent supplements an LLM with additional functionality that illustratively includes, for example, short-term and long-term memory, self-reflection functionality, chain of thoughts (CoT) functionality, subgoal decomposition functionality, and additional or alternative types of LLM agent functionality.

Such LLM agents in some embodiments comprise respective software-based agents. In some embodiments, multiple LLM agents interact with the same LLM, although it is possible that the multiple LLM agents in other embodiments can interact with different LLMs, such as different versions of a given LLM. Numerous other arrangements are possible. For example, in some embodiments, at least portions of the one or more LLMs can be incorporated into at least one of the multiple LLM agents.

The system 100 comprising the AI platform 102, the LLM agents 104 and the user devices 106 is an example of what is more generally referred to herein as an “information processing system.” Other examples of information processing systems are described elsewhere herein, and the term is intended to be broadly construed to encompass, for example, various arrangements of one or more processing devices, with each such processing device comprising at least one processor and at least one memory coupled to the at least one processor.

Also, the term “user” herein is intended to be broadly construed so as to encompass numerous arrangements of human, hardware, software or firmware entities, as well as combinations of such entities.

Compute, storage and/or network services may be provided for users of the AI platform 102 of system 100 in some embodiments under a Platform-as-a-Service (PaaS) model, an Infrastructure-as-a-Service (IaaS) model, a Function-as-a-Service (FaaS) model and/or a Storage-as-a-Service (STaaS) model, although it is to be appreciated that numerous other arrangements could be used.

Although not explicitly shown in FIG. 1, one or more networks are assumed to be deployed in system 100 to interconnect the AI platform 102 and the user devices 106. Such networks can comprise, for example, a portion of a global computer network such as the Internet, a wide area network (WAN), a local area network (LAN), a satellite network, a telephone or cable network, a cellular network such as 4G or 5G network, a wireless network such as a WiFi or WiMAX network, or various portions or combinations of these and other types of networks. The system 100 in some embodiments therefore comprises combinations of multiple different types of networks. Such networks can support inter-device communications utilizing Internet Protocol (IP) and/or a wide variety of other communication protocols.

An example of the manner in which a given one of the LLM agents 104 implements interactive image understanding based on image segmentation will now be described in greater detail.

In this example, the given LLM agent is illustratively configured to perform interactive image segmentation of at least one input image through interaction of the LLM agent with one or more users, to generate an interactive image understanding comprising attention values computed by multiple distinct attention mechanisms based on one or more results of the interactive image segmentation, and to carry out additional user interactions utilizing the interactive image understanding comprising the attention values computed by the multiple distinct attention mechanisms. Additional or alternative processing operations can be performed by the given LLM agent in other embodiments.

The given LLM agent illustratively comprises a multimodal LLM agent that implements at least one multimodal LLM. Other embodiments can be implemented using other types of LLMs that are not necessarily multimodal.

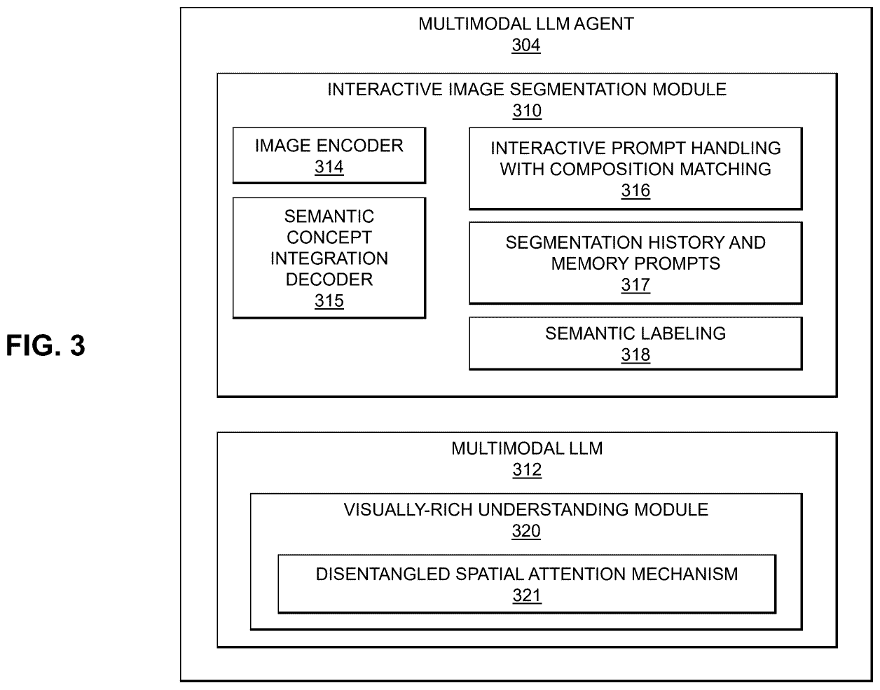

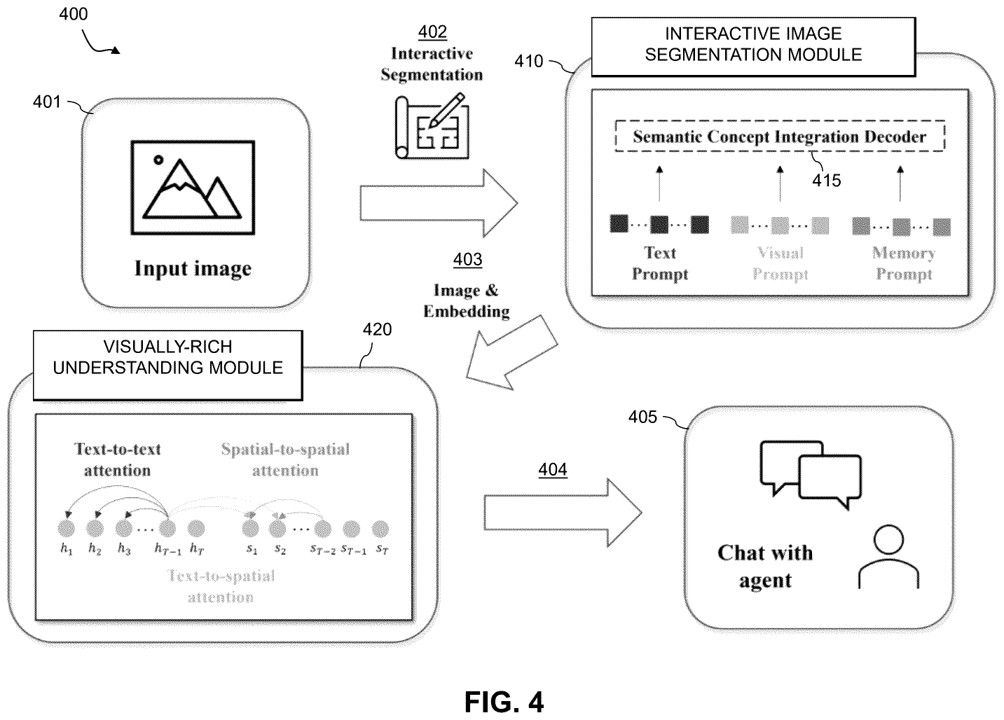

In some embodiments, performing interactive image segmentation illustratively comprises extracting features from the at least one input image in an image encoder, and applying the extracted features to a semantic concept integration decoder to generate at least one embedding. Additional details of such an encoder-decoder architecture will be provided below in conjunction with FIGS. 3 and 4.

Additionally or alternatively, performing interactive image segmentation in some embodiments comprises determining at least a subset of text prompts, visual prompts and memory prompts associated with the at least one input image, and generating at least one embedding comprising at least one of one or more mask embeddings and one or more class embeddings based on the at least a subset of the text prompts, visual prompts and memory prompts and features extracted from the at least one input image.

In some embodiments, generating an interactive image understanding comprises receiving at least one embedding as the one or more results of the interactive image segmentation, and applying the at least one embedding to a transformer architecture comprising the multiple distinct attention mechanisms to generate respective ones of the attention values.

The transformer architecture in some embodiments is configured to treat spatial information and text information as respective separate spatial and text modalities, with at least a portion of the attention values illustratively reflecting interdependencies between the spatial and text modalities.

The multiple distinct attention mechanisms in some embodiments comprise at least a subset of text-to-text attention, text-to-spatial attention, spatial-to-text attention, and spatial-to-spatial attention. Other types and arrangements of multiple distinct attention mechanisms can be used in other embodiments.

In some embodiments, the given LLM agent is illustratively utilized to provide at least a portion of an AI chatbot. The given LLM agent can support numerous other use cases in a wide variety of different applications.

Each of the other LLM agents 104 is illustratively configured to operate in a manner similar to that described above for the given LLM agent.

The above-described functionality of the LLM agents 104 in some embodiments represents examples of one or more algorithms performed by the AI platform 102. Such an algorithm is illustratively implemented utilizing processor and memory components of at least one processing platform that includes at least one processing device. For example, at least portions of the LLM agents 104 may be implemented at least in part in the form of software that is stored in memory and executed by a processor of one or more processing devices.

These and other features and functionality of the system 100 are illustratively implemented at least in part by or under the control of the LLM agents 104.

It is to be appreciated that the particular arrangement of the AI platform 102, the LLM agents and the user devices 106 illustrated in the FIG. 1 embodiment is presented by way of example only, and alternative arrangements can be used in other embodiments. As discussed above, for example, in some embodiments at least one of the LLM agents 104 may be implemented at least in part internally to at least one of the user devices 106.

It is also to be understood that the particular set of elements shown in FIG. 1 for implementing LLM agents 104 with interactive image understanding based on image segmentation is presented by way of illustrative example only, and in other embodiments additional or alternative elements may be used. Thus, another embodiment may include additional or alternative systems, devices and other entities, as well as different arrangements of modules and other components.

As indicated previously, the AI platform 102, and possibly other portions of the system 100, may be implemented at least in part in cloud infrastructure.

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for different ones of the LLM agents 104, or portions or components thereof, to reside in different data centers or other different geographic locations. Numerous other distributed implementations are possible.

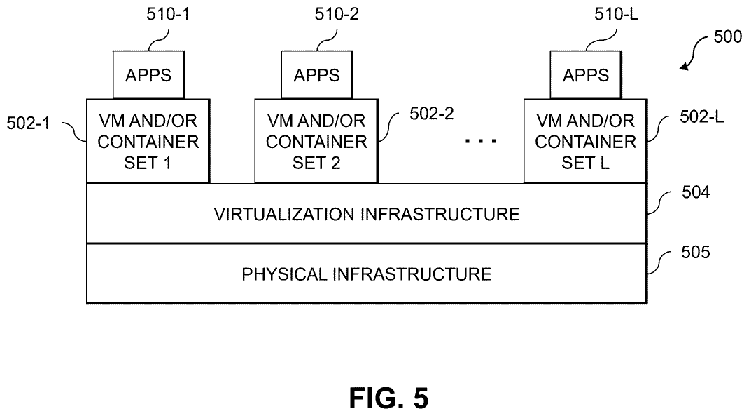

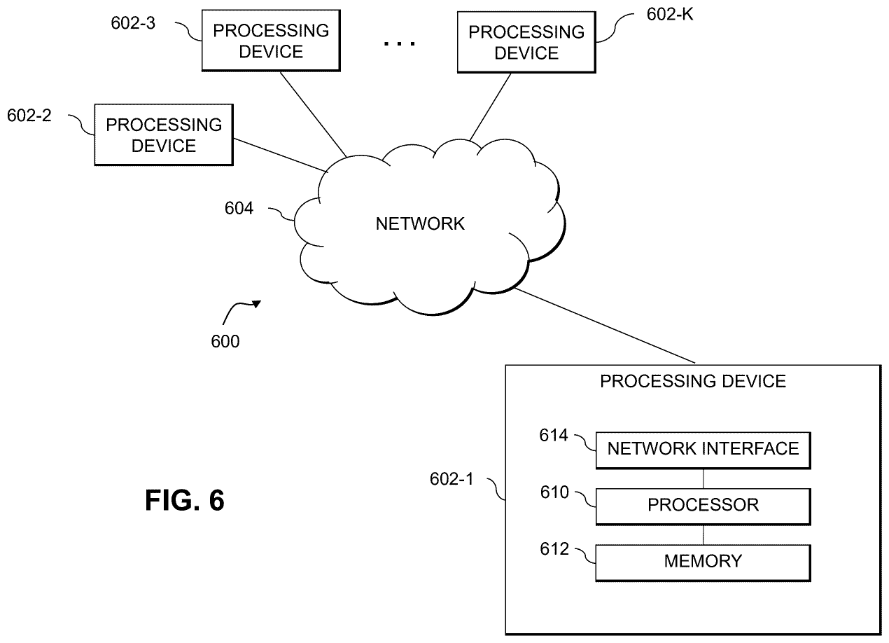

Additional examples of processing platforms utilized to implement the AI platform 102, the LLM agents 104 and the user devices 106, and possibly additional or alternative components of the system 100 in illustrative embodiments will be described in more detail below in conjunction with FIGS. 5 and 6.

It is to be appreciated that these and other features of illustrative embodiments are presented by way of example only, and should not be construed as limiting in any way.

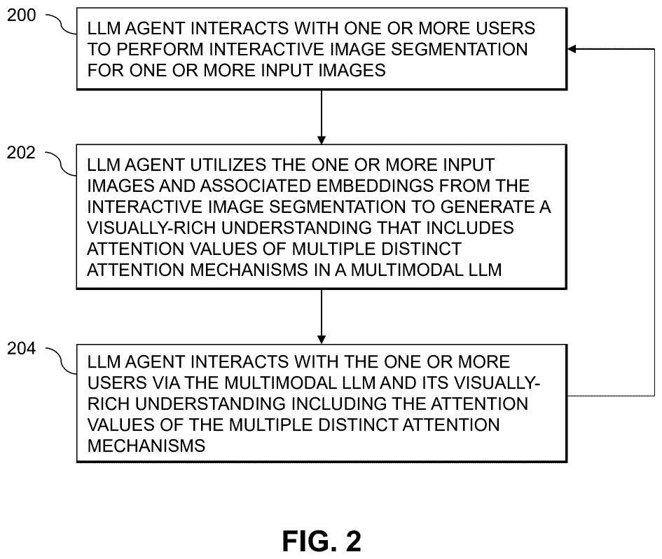

An exemplary process for interactive image understanding will now be described in more detail with reference to the flow diagram of FIG. 2. It is to be understood that this particular process is only an example, and that additional or alternative processes for interactive image understanding may be used in other embodiments.

In this embodiment, the process includes steps 200 through 204. These steps are assumed to be performed by a given one of the LLM agents 104 through interaction with one or more of the user devices 106, although it is to be appreciated that other arrangements of system components can implement this or other similar processes in other embodiments. In some embodiments, the FIG. 2 process more particularly represents an example algorithm performed at least in part by a given one of the LLM agents 104.

In step 200, the LLM agent interacts with one or more users to perform interactive image segmentation for one or more input images. This may involve, for example, extracting features from the at least one input image in an image encoder, and applying the extracted features to a semantic concept integration decoder to generate at least one embedding. In some embodiments, the semantic concept integration decoder is configured to determine at least a subset of text prompts, visual prompts and memory prompts associated with the at least one input image, and to generate at least one embedding comprising at least one of one or more mask embeddings and one or more class embeddings based on the at least a subset of the text prompts, visual prompts and memory prompts and features extracted from the at least one input image. Other encoder-decoder architectures may be used in other embodiments to perform the interactive image segmentation for the one or more input images.

In step 202, the LLM agent utilizes the one or more input images and associated embeddings from the interactive image segmentation to generate a visually-rich understanding that includes attention values of multiple distinct attention mechanisms in a multimodal LLM. For example, generating an interactive image understanding in some embodiments may comprise receiving at least one embedding as the one or more results of the interactive image segmentation, and applying the at least one embedding to a transformer architecture comprising the multiple distinct attention mechanisms to generate respective ones of the attention values. The transformer architecture in some embodiments is configured to treat spatial information and text information as respective separate spatial and text modalities, with at least a portion of the attention values illustratively reflecting interdependencies between the spatial and text modalities. For example, the multiple distinct attention mechanisms comprise at least a subset of text-to-text attention, text-to-spatial attention, spatial-to-text attention, and spatial-to-spatial attention, although other attention mechanisms can be used.

In step 204, the LLM agent interacts with the one or more users via the multimodal LLM and its visually-rich understanding including the attention values of the multiple distinct attention mechanisms. For example, in some embodiments, the attention values are generated in the course of the LLM agent carrying out an interactive chat with a given user, although numerous other use cases and applications as possible.

The process then returns to step 200 to process additional input images and other information received from one or more users through additional interactions between the LLM agent and the one or more users.

Further examples of the interactive image segmentation and interactive image understanding illustrated by the FIG. 2 process will be described in more detail below with reference to the illustrative embodiments of FIGS. 3 and 4.

The particular processing operations and other system functionality described in conjunction with the flow diagram of FIG. 2 are presented by way of illustrative example only, and should not be construed as limiting the scope of the disclosure in any way. Alternative embodiments can use other types of processing operations involving LLM agents and associated functionality for interactive image understanding. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement a plurality of different interactive image understanding arrangements within a given information processing system.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Additional illustrative embodiments will now be described with reference to FIGS. 3 and 4. The particular details of these embodiments, like the other embodiments disclosed herein, and provided by way of example only, and should not be viewed as limiting the scope of the present disclosure in any way.

FIG. 3 shows a multimodal LLM agent 304 with interactive image understanding in an illustrative embodiment. The multimodal LLM agent 304 in this embodiment comprises an interactive image segmentation module 310 and a multimodal LLM 312 that includes a visually-rich understanding module 320.

The interactive image segmentation module 310 includes an image encoder 314, a semantic concept integration decoder 315, a module 316 for interactive prompt handing with composition matching, a segmentation history and memory prompts module 317, and a semantic labeling module 318.

In some embodiments, the interactive image segmentation module 310 is configured to allow one or more users to mark parts of an image that require focused attention through interactive mechanisms such as points and boxes. The results of this marking are illustratively learned and encoded into embeddings, which are passed to the visually-rich understanding module 320 along with the image itself.

The visually-rich understanding module 320 comprises a disentangled spatial attention mechanism 321. In some embodiments, the visually-rich understanding module 320 is more particularly implemented as a visually-rich document understanding module, as will be described in detail below. Such a module is illustratively part of multimodal LLM 312 and is configured for understanding visually-rich textual information. For example, it can process all the information transmitted from the interactive image segmentation module 310 to better understand an input image. In some embodiments, it can perform more complex searches on various types of documents, including tables, contracts, and specification files, using visually-rich document understanding, thereby answering user queries more accurately.

Although shown in this embodiment as being implemented within the multimodal LLM 312, in other embodiments the visually-rich understanding module 320 may be implemented at least in part externally to the multimodal LLM 312.

Additionally or alternatively, the multimodal LLM 312 in other embodiments can be implemented at least in part externally to the multimodal LLM agent 304, rather than internally to the multimodal LLM agent 304 as is illustratively shown in the figure.

The interactive image segmentation module 310 and the visually-rich understanding module 320 in this embodiment provide the multimodal LLM agent 304 with “interactive image understanding” functionality as that term is broadly used herein. These modules 310 and 320 in some embodiments are loosely coupled, such that each of the modules can be separately and conveniently updated or replaced.

It should be noted in this regard that the particular arrangement of modules shown in the multimodal LLM agent 304 is presented by way of illustrative example only, and the disclosed LLM agent functionality can be implementing using a wide variety of different arrangements of more or fewer modules in other embodiments. Each such module may be implemented at least in part in the form of software that is stored in memory and executed by one or more processors in one or more processing devices of a processing platform, such as the AI platform 102 of system 100 of FIG. 1.

The interactive image segmentation module 310 and the visually-rich understanding module 320 will each be described in further detail below.

### Interactive Image Segmentation Module

The interactive image segmentation module 310 is illustratively configured to allow for the segmentation of any object in a given input image, as well as segmentation at any pixel location within the input image, through dynamic interaction with one or more users, with the interaction types taking on any of a variety of different forms, such as, for example, clicks, boxes, polygons, and scribbles. The interactive image segmentation module 310 in this embodiment implements an encoder-decoder architecture that includes the image encoder 314 and the semantic concept integration decoder 315.

The image encoder 314 is illustratively configured to process input images in order to extract features therefrom. For example, the image encoder 314 is illustratively configured to recognize and interpret various image formats, ensuring that minute details are captured for accurate processing. The extracted features form the basis of subsequent processing stages, which collectively allow the multimodal LLM agent 304 to handle complex visual data.

The semantic concept integration decoder 315 is responsible for predicting masks and identifying semantic concepts. It receives the features generated by the image encoder 314, and generates output that incorporates a deep understanding of the context and content of the images. This advantageously allows the multimodal LLM agent 304 to not only identify objects and scenes but also to understand their semantic implications, making the overall process more intuitive and accurate.

The input and output of the semantic concept integration decoder 315 in some embodiments is given by Equation (1) below:

$$〈 {E}_{m ask} , {E}_{c l a s s} 〉 = {ℱ}_{D e c o d e r} ( Q ; 〈 {P}_{txt} , {P}_{vis} , {P}_{m e m} 〉 \vert {F}_{i m g} ) \qquad ( 1 )$$

where Q is a learnable query, Pₜₓₜ, Pᵥᵢₛ, Pₘₑₘ represent text prompts, visual prompts, and memory prompts, respectively, and F_{img} represents the extracted image features. After decoding, mask embeddings Eₘₐₛₖ and class embeddings E_{class} are obtained, which are delivered with the input image to the visually-rich understanding module 320.

The module 316 for interactive prompt handing with composition matching is configured to handle a versatile range of prompts, including visual prompts. These prompts illustratively include non-textual inputs like points and boxes. This module is equipped to interpret these visual cues effectively, converting them into meaningful data that can be processed alongside textual inputs. This feature opens up new possibilities for user interaction, allowing for more natural and intuitive input methods.

In some embodiments, visual prompts are illustratively computed by module 316 in accordance with Equation (2) below:

$${P}_{v i s} = {Sampler}_{V} ( {s}_{l o c} , {F}_{img}^{′} ) \qquad ( 2 )$$

where

$${F}_{img}^{′}$$

denotes the feature maps extracted from either the target image or a referred image, and s_{loc} ∈{points, box} denotes the sampling locations specified by the user.

The module 316 in some embodiments is further configured to provide compositional matching of different types of prompts with corresponding outputs. This compositional matching is central to addressing varied user intents. Whether the user provides textual descriptions, visual pointers, or a combination of both, the module 316 can interpret and respond appropriately. This flexibility ensures that the multimodal LLM agent 304 caters to a wide range of segmentation tasks, from simple object identification to complex scene analysis.

The segmentation history and memory prompts module 317 is configured to implement retention of segmentation history and incorporation of memory prompts. With regard to retention of segmentation history, interactivity is fundamental to the operation of the multimodal LLM agent 304, and the segmentation history and memory prompts module 317 retains a history of segmentation. This means that the multimodal LLM agent 304 remembers previous interactions and decisions, allowing for a more cohesive and continuous user experience. Users can build upon previous segmentations, refine them, or explore different paths without starting from scratch each time. In addition to retaining segmentation history, the segmentation history and memory prompts module 317 also incorporates memory prompts. These prompts enable the multimodal LLM agent 304 to refer back to earlier inputs and decisions, facilitating refinement in subsequent rounds. This feature is particularly useful in complex segmentation tasks where incremental improvements and adjustments are necessary.

In some embodiments, the segmentation history and memory prompts module 317 illustratively uses a masked cross-attention layer to aggregate masks

$${Predictor}_{M}^{prev}$$

and previous memory prompts

$${P}_{mem}^{p r e v}$$

to obtain Pₘₑₘ in accordance with Equation (3) below:

$${P}_{m e m} = {CrossAttention}_{M} ( {P}_{m e m}^{p r e v} ; {Predictor}_{M}^{prev} ( {E}_{m a s k} ) \vert {F}_{img} ) \qquad ( 3 )$$

The semantic labeling module 318 provides semantic awareness and adaptability at least in part by producing semantic labels. For example, in some embodiments, it not only identifies and segments images but also assigns semantic labels to the resulting masks. This capability allows the multimodal LLM agent 304 to understand and categorize the content of images in a way that aligns with human understanding. Whether dealing with simple objects or complex scenes, the semantic labeling module 318 is configured to provide labels that are both accurate and contextually relevant.

The interactive image segmentation module 310 as described above is configured to provide a high level of adaptability across tasks. For example, it is illustratively configured to support a wide variety of segmentation tasks, involving different types of inputs and user requirements, from a straightforward object identification to a complex scene analysis involving multiple elements. It delivers accurate and efficient results across these various tasks, making it suitable for use in a wide range of applications, from academic research to numerous practical, real-world scenarios.

### Visually-Rich Understanding Module

As indicated previously, in some embodiments the visually-rich understanding module 320 is more particularly implemented at least in part as a visually-rich document understanding module. Such a module is illustratively configured to analyze documents with complex layouts, combining textual and visual elements. In some embodiments, the visually-rich understanding module 320 is implemented at least in part utilizing an auto-regressive transformer architecture that treats spatial information as a separate modality, distinct from text. More particularly, this architecture in illustrative embodiments extends the transformer self-attention mechanism to compute inter-dependencies between these two modalities, spatial information and text information. Unlike traditional models that predict the next token in a sequence, the visually-rich understanding module 320 uses a text infilling objective, better aligning with the irregular layouts of visual documents. This unique approach allows for more effective processing of spatial and textual data in complex documents.

The above-described auto-regressive transformer that integrates text with spatial information comprises the disentangled spatial attention mechanism 321, which allows the multimodal LLM agent to selectively focus on either text or spatial elements, providing a nuanced understanding of documents. By employing four distinct attention computations, which are text-to-text, text-to-spatial, spatial-to-text, and spatial-to-spatial, the disentangled spatial attention mechanism 321 allows the multimodal LLM agent 304 to effectively discern the intricate relationship between text and its spatial context. This disentanglement supports highly accurate processing and interpretation of visually-rich documents, where the layout and text are deeply interconnected yet functionally distinct. It provides the multimodal LLM agent 304 with an ability to handle the complexities inherent in multimodal document understanding, setting it apart from traditional models that are limited to sequential text prediction. The disentangled spatial attention mechanism 321 advantageously empowers the multimodal LLM agent 304 to navigate the complexities of varied document formats, making it a potent tool for diverse document analysis tasks.

In some embodiments, the disentangled spatial attention mechanism 321 performs the four distinct attention computations in the manner shown in Equations (4) and (5) below:

$$Q = S {W}_{q} K = S {W}_{k} \qquad ( 4 )$$

$${A}_{i , j} = {λ}_{i} {Q}_{i} {K}_{j}^{T} + {λ}_{2} {Q}_{i} {K}_{j}^{T} + {λ}_{3} {Q}_{i} {K}_{j}^{T} + {λ}_{4} {Q}_{i} {K}_{j}^{T} \qquad ( 5 )$$

In Equation (4), S illustratively represents spatial information comprising hidden vectors encoding bounding boxes of an image, W_{q} and Wₖ are projection matrices corresponding to the spatial modality, Q and K are the products of the hidden vectors and the respective projection matrices, and Δ in Equation (5) with different subscripts represents four hyper-parameters, corresponding to the calculation methods of the four distinct attention computations collectively comprising attention A_{i,j}, where i and j are respective indices.

Referring now to FIG. 4, an example of the operation of a multimodal LLM agent with interactive image understanding in an illustrative embodiment is shown. In this embodiment, an information processing system 400 receives an input image 401, illustratively from a user device that is not explicitly shown. The system 400 processes the input image using a sequence of processing operations generally denoted by reference numerals 402, 403, 404 and 405, using a multimodal LLM agent that includes an interactive image segmentation module 410 and a visually-rich understanding module 420. The multimodal LLM agent in this embodiment may be, for example, a particular one of the LLM agents 104 of system 100 of FIG. 1 or multimodal LLM agent 304 of FIG. 3. The interactive image segmentation module 410 and the visually-rich understanding module 420 of the multimodal LLM agent are assumed to operate in a manner similar to that previously described for the respective corresponding modules of FIG. 3.

In this embodiment, input image 401 is illustratively provided by a user, in association with one or more interactions collectively comprising an interactive segmentation 402, as inputs to the interactive image segmentation module 410 as shown. The interactive image segmentation module 410 generates an embedding via semantic concept integration decoder 415, illustratively using text prompts, visual prompts and memory prompts as illustrated. In some embodiments, the embedding may comprise, for example, a multimodal embedding into a shared vector space in which vectors characterizing image information and text information having similar content are close to one another in the shared vector space. The embedding in some embodiments involves generating separate vectors for each of a plurality of different content modalities of the input image. Numerous other embedding techniques can be used, and the term “embedding” as used herein is intended to be broadly construed.

The input image and its corresponding embedding are provided by the interactive image segmentation module 410 to the visually-rich understanding module 420 as illustrated by reference numeral 403. The visually-rich understanding module 420 processes the input image and its corresponding embedding, illustratively utilizing multiple ones of the above-described attention computations of the disentangled spatial attention mechanism 321 performs the four distinct attention computations. For example, as illustrated in the figure, visually-rich understanding module 420 utilizes at least text-to-text attention based on example text information h₁, h₂, h₃ . . . h_{T-1}, h_{T}, spatial-to-spatial attention based on example spatial information s₁, s₂, s₃ . . . s_{T-1}, s_{T}, and text-to-spatial attention involving both the text information and the spatial information.

The resulting output indicated by reference numeral 404 is utilized to support an ongoing chat 405 between the user and the multimodal LLM agent.

Again, the particular modules and processing operations described in conjunction with the diagrams of FIGS. 3 and 4 are presented by way of illustrative example only, and should not be construed as limiting the scope of the disclosure in any way. Alternative embodiments can use other types of modules and processing operations to implement LLM agents with functionality for interactive image understanding.

As indicated previously, the illustrative embodiments disclosed herein can provide a number of significant advantages relative to conventional arrangements.

For example, some embodiments are advantageously configured to provide a multimodal LLM agent with interactive image understanding.

In some embodiments, an LLM agent, through interactive image segmentation, allows a user to specify parts of an image that require focused attention, thus clarifying the content within the image that genuinely interests the user.

Additionally, the LLM agent in some embodiments employs rich document understanding techniques for visual content, achieving a deeper comprehension of various documents. This gives the LLM agent a more comprehensive background knowledge and document understanding ability compared to conventional LLMs.

These and other embodiments can enhance the accuracy of multimodal LLMs in understanding user intentions while also improving their ease of use.

For example, illustrative embodiments disclosed herein can be used to provide a more intelligent and user-friendly LLM-based AI-driven customer interface for a wide variety of different contexts and applications. As a more particular example, a customer service robot implemented with a multimodal LLM agent as disclosed herein will have a better understanding of user needs and will be able to respond to user queries more accurately and effectively and with enhanced timeliness.

Some embodiments provide techniques for precisely directing the focus of an LLM to specific objects within images, so as to provide enhanced comprehension of user queries.

These and other embodiments can be configured to increase the interactivity between multimodal LLMs and users in a manner that leverages and expands the functionalities of the multimodal LLMs in processing various data types.

One or more such advantages are illustratively achieved in some embodiments without requiring additional data training, thereby enabling multimodal LLMs to be more versatile in numerous and diverse application scenarios, at low cost and yet in a manner that supports output standardization and convenient updates over time.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement hosts and distributed storage systems with dynamic resource adjustment functionality will now be described in greater detail with reference to FIGS. 5 and 6. Although described in the context of system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that may be utilized to implement at least a portion of the information processing system 100. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 may comprise respective VMs, respective sets of one or more containers, or respective sets of one or more containers running in VMs.

In some implementations of the FIG. 5 embodiment, the VMs/container sets 502 comprise respective VMs implemented using virtualization infrastructure 504 that comprises at least one hypervisor. Such implementations can provide functionality for one or more aspects of interactive image understanding of the type disclosed herein using one or more processes running on a given one of the VMs. For example, each of the VMs can include logic instances and/or other components for implementing at least portions of the disclosed multimodal LLM agent with interactive image understanding in the system 100.

A hypervisor platform may be used to implement a hypervisor within the virtualization infrastructure 504. Such a hypervisor platform may comprise an associated virtual infrastructure management system. The underlying physical machines may comprise one or more distributed processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system. Such implementations can also provide functionality for one or more aspects of interactive image understanding of the type disclosed herein. For example, a container host supporting multiple containers of one or more container sets can include logic instances and/or other components for implementing at least portions of the disclosed multimodal LLM agent with interactive image understanding in the system 100.

As is apparent from the above, one or more of the processing devices or other components of system 100 may each run on a computer, server, storage device or other processing platform element. A given such element may be viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of system 100 and includes a plurality of processing devices, denoted 602-1, 602-2, 602-3, . . . 602-K, which communicate with one another over a network 604.

The network 604 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 602-1 in the processing platform 600 comprises a processor 610 coupled to a memory 612.

The processor 610 may comprise a microprocessor, a microcontroller, an application-specific integrated circuit (ASIC), a field-programmable gate array (FPGA), a graphics processing unit (GPU), a tensor processing unit (TPU) or other type of processing circuitry, as well as portions or combinations of such circuitry elements.

The memory 612 may comprise random access memory (RAM), read-only memory (ROM), flash memory or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise various arrangements of converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for interactive image understanding as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, processing devices, AI systems, LLMs, LLM agents, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to implement an artificial intelligence system comprising at least one large language model (LLM) agent;
to perform in the LLM agent interactive image segmentation of at least one input image through interaction of the LLM agent with one or more users;
to generate in the LLM agent an interactive image understanding comprising attention values computed by multiple distinct attention mechanisms based on one or more results of the interactive image segmentation; and
to carry out additional user interactions via the LLM agent utilizing the interactive image understanding comprising the attention values computed by the multiple distinct attention mechanisms.

2. The apparatus of claim 1 wherein the artificial intelligence system is implemented at least in part on a processing platform that is configured to communicate with one or more user devices over at least one network.

3. The apparatus of claim 1 wherein the artificial intelligence system is implemented at least in part on at least one user device.

4. The apparatus of claim 1 wherein the LLM agent comprises a multimodal LLM agent that implements at least one multimodal LLM.

5. The apparatus of claim 1 wherein performing interactive image segmentation comprises:
extracting features from the at least one input image in an image encoder; and
applying the extracted features to a semantic concept integration decoder to generate at least one embedding.

6. The apparatus of claim 1 wherein performing interactive image segmentation comprises:
determining at least a subset of text prompts, visual prompts and memory prompts associated with the at least one input image; and
generating at least one embedding comprising at least one of one or more mask embeddings and one or more class embeddings based on said at least a subset of the text prompts, visual prompts and memory prompts and features extracted from the at least one input image.

7. The apparatus of claim 1 wherein generating an interactive image understanding comprises:
receiving at least one embedding as the one or more results of the interactive image segmentation; and
applying the at least one embedding to a transformer architecture comprising the multiple distinct attention mechanisms to generate respective ones of the attention values.

8. The apparatus of claim 7 wherein the transformer architecture is configured to treat spatial information and text information as respective separate spatial and text modalities and wherein at least a portion of the attention values reflect interdependencies between the spatial and text modalities.

9. The apparatus of claim 7 wherein the multiple distinct attention mechanisms comprise at least a subset of text-to-text attention, text-to-spatial attention, spatial-to-text attention, and spatial-to-spatial attention.

10. The apparatus of claim 1 wherein the LLM agent provides at least a portion of an AI chatbot.

11. A computer program product comprising a non-transitory processor-readable storage medium having stored therein program code of one or more software programs, wherein the program code when executed by at least one processing device causes the at least one processing device:
to implement an artificial intelligence system comprising at least one large language model (LLM) agent;
to perform in the LLM agent interactive image segmentation of at least one input image through interaction of the LLM agent with one or more users;
to generate in the LLM agent an interactive image understanding comprising attention values computed by multiple distinct attention mechanisms based on one or more results of the interactive image segmentation; and
to carry out additional user interactions via the LLM agent utilizing the interactive image understanding comprising the attention values computed by the multiple distinct attention mechanisms.

12. The computer program product of claim 11 wherein performing interactive image segmentation comprises:
extracting features from the at least one input image in an image encoder; and
applying the extracted features to a semantic concept integration decoder to generate at least one embedding.

13. The computer program product of claim 11 wherein performing interactive image segmentation comprises:
determining at least a subset of text prompts, visual prompts and memory prompts associated with the at least one input image; and
generating at least one embedding comprising at least one of one or more mask embeddings and one or more class embeddings based on said at least a subset of the text prompts, visual prompts and memory prompts and features extracted from the at least one input image.

14. The computer program product of claim 11 wherein generating an interactive image understanding comprises:
receiving at least one embedding as the one or more results of the interactive image segmentation; and
applying the at least one embedding to a transformer architecture comprising the multiple distinct attention mechanisms to generate respective ones of the attention values.

15. The computer program product of claim 14 wherein the transformer architecture is configured to treat spatial information and text information as respective separate spatial and text modalities, wherein at least a portion of the attention values reflect interdependencies between the spatial and text modalities, and wherein the multiple distinct attention mechanisms comprise at least a subset of text-to-text attention, text-to-spatial attention, spatial-to-text attention, and spatial-to-spatial attention.

16. A method comprising:
implementing an artificial intelligence system comprising at least one large language model (LLM) agent;
performing in the LLM agent interactive image segmentation of at least one input image through interaction of the LLM agent with one or more users;
generating in the LLM agent an interactive image understanding comprising attention values computed by multiple distinct attention mechanisms based on one or more results of the interactive image segmentation; and
carrying out additional user interactions via the LLM agent utilizing the interactive image understanding comprising the attention values computed by the multiple distinct attention mechanisms;
wherein the method is performed by at least one processing device comprising a processor coupled to a memory.

17. The method of claim 16 wherein performing interactive image segmentation comprises:
extracting features from the at least one input image in an image encoder; and
applying the extracted features to a semantic concept integration decoder to generate at least one embedding.

18. The method of claim 16 wherein performing interactive image segmentation comprises:
determining at least a subset of text prompts, visual prompts and memory prompts associated with the at least one input image; and
generating at least one embedding comprising at least one of one or more mask embeddings and one or more class embeddings based on said at least a subset of the text prompts, visual prompts and memory prompts and features extracted from the at least one input image.

19. The method of claim 16 wherein generating an interactive image understanding comprises:
receiving at least one embedding as the one or more results of the interactive image segmentation; and
applying the at least one embedding to a transformer architecture comprising the multiple distinct attention mechanisms to generate respective ones of the attention values.

20. The method of claim 19 wherein the transformer architecture is configured to treat spatial information and text information as respective separate spatial and text modalities, wherein at least a portion of the attention values reflect interdependencies between the spatial and text modalities, and wherein the multiple distinct attention mechanisms comprise at least a subset of text-to-text attention, text-to-spatial attention, spatial-to-text attention, and spatial-to-spatial attention.
